(19) United States
(12) Patent Application Publication
(10) Pub. No.: US 2007/0291058 A1
(43) Pub. Date: Dec. 20, 2007

(54) CONTINUOUS INK JET PRINTING WITH SATELLITE DROPLETS

(76) Inventors: Randy L. Fagerquist, Fairborn, OH (US); Qing Yang, Pittsford, NY (US)

Correspondence Address: EASTMAN KODAK COMPANY;PATENT LEGAL STAFF, 343 STATE STREET, ROCHESTER, NY, 14650-2201, US

(21) Appl. No.: 11/425,278

(22) Filed: Jun. 20, 2006

(51) Int. Cl. B41J 29/38

(52) U.S. Cl. 347/11; 347/15

(57) ABSTRACT

Satellite droplets that have a lifetime selectable between an infinite lifetime and a finite lifetime are formed with a continuous fluid-jet system having a drop generator, a stimulation device, and a nozzle plate with at least one nozzle opening. A force is applied to eject a fluid jet having a diameter D from the nozzle openings and an adjustable energy drive pulse is applied to the stimulation device in a manner to create a series of perturbations on the ejected fluid jet, such that the perturbations are separated by a distance λ. The drive pulse is defined by a pulse shape, a pulse amplitude, and a pulse duty cycle. A first satellite formation state is established by adjusting the energy of the drive pulse while operating the continuous fluid-jet system in a state wherein the λ/D values are greater than π and correspond to the measured normalized Rayleigh growth rate within or beyond the first minimum. The drive pulse is adjusted in a manner to bring about a second satellite formation state after at least 1 λ of the first satellite formation state.

### FIELD OF THE INVENTION

The present invention relates generally to continuous ink jet printers, and more particularly to the production of desired satellite droplets for printing.

### BACKGROUND OF THE INVENTION

Traditionally, digitally controlled color printing capability is accomplished by one of two technologies. Liquid, such as ink, is fed through channels formed in a print head. Each channel includes a nozzle from which drops are selectively extruded and deposited upon a medium.

The first technology, commonly referred to as “drop on demand” printing, provides drops for impact upon a recording surface. Selective activation of an actuator causes the formation and ejection of a flying drop that strikes the print media. The formation of printed images is achieved by controlling the individual formation of drops. For example, in a bubble jet printer, liquid in a channel of a print head is heated creating a bubble that increases internal pressure to eject a drop out of a nozzle of the print head. Piezoelectric actuators, such as that disclosed in U.S. Pat. No. 5,224,843, issued to VanLintel, on Jul. 6, 1993, have a piezoelectric crystal in a fluid channel that flexes when an electric current flows through it forcing a drop out of a nozzle.

The second technology commonly referred to as “continuous stream” or “continuous” printing, uses a pressurized liquid source that produces a continuous stream of drops. Conventional continuous printers utilize electrostatic charging devices that are placed close to the point where a filament of working fluid breaks into individual drops. The drops are electrically charged and then directed to an appropriate location by deflection electrodes having a large potential difference. When no print is desired, the drops are deflected into a liquid capturing mechanism commonly referred to as a catcher, an interceptor, a gutter, etc. and either recycled or disposed of. When print is desired, the drops are not deflected and allowed to strike a print media. Alternatively, deflected drops may be allowed to strike the print media, while non-deflected drops are collected in the capturing mechanism.

As conventional continuous printers utilize electrostatic charging devices and deflector plates, they require many components and large spatial volumes in which to operate. This results in continuous print heads and printers are complicated, have high-energy requirements, are difficult to manufacture, and are difficult to control.

U.S. Pat. No. 3,709,432, issued to Robertson, on Jan. 9, 1973, discloses a method and apparatus for stimulating a filament of working fluid causing the working fluid to break up into uniformly spaced drops through the use of transducers. The lengths of the filaments before they break up into drops are regulated by controlling the stimulation energy supplied to the transducers, with high amplitude stimulation resulting in short filaments and low amplitudes resulting in long filaments. A flow of air is generated across the paths of the fluid at a point intermediate to the ends of the long and short filaments. The air flow affects the trajectories of the filaments before they break up into drops more than it affects the trajectories of the drops themselves. By controlling the lengths of the filaments, the trajectories of the drops can be controlled, or switched from one path to another. As such, some drops may be directed into a catcher while allowing other drops to be applied to a receiving member.

Commonly assigned U.S. Patent Application 6,554,410 issued in the name David L. Jeanmaire et al. on Apr. 29, 2003, discloses so-called “stream” continuous-jet printing wherein nozzle heaters are selectively actuated at a plurality of frequencies to create the stream of drops having the plurality of volumes. A force is applied to the drops at an angle to the stream to separate the drops into printing and non-printing paths according to drop volume. The force is applied by a flow of gas. This process consumes little power, and is suitable for printing with a wide range of inks.

Continuous-jet printing can be implemented in either of two complementary modes. The first is the so-called “large-drop” mode in which large drops are directed to the image receiver and small droplets are captured by a gutter. In the second, “small-drop” mode, large drops are guttered, while smaller drops impact upon the image receiver. In large-drop mode, liquid utilization can reach 100%, but only at the expense of a loss in attainable resolution. Small-drop mode printers print with the greatest possible resolution, but cannot normally reach 100% of liquid utilization. Typically, a system running in small-drop mode has a liquid utilization factor less than 50%. Therefore, it would be beneficial to operate current continuous ink jet printing systems in a manner such that either large or small droplets may be obtained for printing purposes.

An ink jet filament issuing from a nozzle breaks up into uniformly spaced drops that tend to produce small satellite droplets that separate from, and are interspersed among, the main drops. The existence of satellite droplets is typically considered to be adverse to the printing process, and much research has gone into technologies to suppress the formation of satellite droplets.

W. T. Pimbley and H. C. Lee described the formation, characterization, and control of satellite droplets in Satellite Droplet Formation in a Liquid Jet, IBM J. Res. Develop. January 1977. Therein were described four particular conditions in which satellite droplets may exist: (1) no satellite droplet formation, (2) forward-merging satellite droplet formation, (3) infinite satellite droplet formation, and (4) rearward-merging satellite droplet formation. Pimbley and Lee teach that, for a given drop-to-drop distance and jet diameter, each condition (1) through (4) is controlled only by modulation of the amplitude of the stimulation energy.

U.S. Pat. No. 5,646,663, which issued to Clark et al. on Jul. 8, 1997, discloses a continuous ink jet printer capable of creating fast satellite droplets. Clark et al. do not suggest an ability to transition between different conditions in which satellite droplets exist.

Ink jet printer design requires balancing the desire for increased resolution associated with smaller drop sizes with the disadvantage that the smaller nozzle diameters required to produce small drops are more prone to clogged nozzles and crooked jets. Furthermore, smaller nozzle diameters require higher ink pressures. Accordingly, it is an object of the present invention to provide a method for selectively creating small satellite printing droplets from a large diameter ink jet nozzle.

Another object of the present invention to operate a continuous ink jet system such that both satellite droplets and main drops are created and maintained without merging.

Still another object of the present invention is to provide a set of operational parameters for the simulation device of a continuous ink jet system such that the lifetime of a satellite droplet is controllable.

Yet another object of the present invention is to provide a set of operational parameters for the stimulation device of a continuous ink jet system such that the volume of the satellite droplet is controlled and preferred to the main drop volume.

It is another object of the present invention to provide a device for alternating the operation of the stimulation device for an individual nozzle such that the jet of fluid from the nozzle ejects infinite satellite droplets when print droplets are required and either rearward- or forward-merging satellite droplets when print droplets are not required.

It is another object of the present invention to create infinite satellite droplets by altering the duty cycle of the stimulation energy, either at a fixed amplitude of the stimulation energy or by simultaneously altering the amplitude of the stimulation energy and the duty cycle. The ability to use duty cycle to control satellite formation provides the greater flexibility of an addition parameter that may be altered to realize infinite satellite formation (when compared to Pimbley and Lee).

It is yet another object of the present invention to be able to transition among the four conditions in which satellite droplets exist between main drops.

It is still another object of the present invention to transition between infinite satellite droplet formation and forward merging satellite droplet formation using thermal stimulation modulation.

### SUMMARY OF THE INVENTION

In accordance with the above objects, it is a feature of the present invention to establish a first satellite droplet formation state by adjusting the energy of the drive pulse while operating the continuous fluid-jet system in a state wherein the measured normalized Rayleigh growth rate for λ/D values greater than π is at a minimum.

It is a feature of the present invention to form satellite droplets that have a lifetime selectable between an infinite lifetime and a finite lifetime with a continuous fluid-jet system having a drop generator, a stimulation device, and a nozzle plate with at least one nozzle opening. A force is applied to the fluid such that a fluid jet having a diameter D is ejected from the nozzle openings. An adjustable energy drive pulse is applied to the stimulation device to create a series of perturbations on the ejected fluid jet, wherein the perturbations are separated by a distance λ. A first satellite formation state is established by adjusting the energy of the drive pulse while operating the continuous fluid-jet system in a state wherein the λ/D values are greater than π and correspond to the measured normalized Rayleigh growth rate within or beyond a first minimum. The drive pulse is adjusted in a manner to bring about a second satellite formation state after at least 1 λ of the first satellite formation state.

It is another feature of the present invention to form satellite droplets that have a lifetime selectable between an infinite lifetime and a finite lifetime by applying a force to a fluid such that a fluid jet having a diameter D is ejected from the nozzle openings. An adjustable energy drive pulse is applied to the stimulation device to create a series of perturbations on the ejected fluid jet so that the perturbations are separated by a distance λ. The drive pulse is adjusted in a manner to bring the continuous fluid-jet system into a state wherein values of λ/D are greater than π and correspond to a measured normalized Rayleigh growth rate within or beyond a first minimum.

In a preferred embodiment of the present invention, the satellite formation state is selectable by altering the pulse duty cycle and keeping the pulse amplitude constant. In another preferred embodiment of the present invention, the satellite formation state is selectable by altering the pulse duty cycle and the pulse amplitude.

### BRIEF DESCRIPTION OF THE DRAWINGS

In the detailed description of the preferred embodiments of the invention presented below, reference is made to the accompanying drawings, in which:

FIG. 1A shows a continuous ink jet print head forming a stream of ink drops;

FIG. 1B shows a continuous ink jet print head forming a stream of main ink drops and interspersed satellite droplets;

FIG. 2 is a diagram of infinite satellite droplet formation and the driving waveform;

FIG. 3 is a diagram of rearward merging satellite droplet formation and the driving waveform;

FIG. 4 is a diagram of forward merging satellite drop formation and the driving waveform;

FIG. 5 is a chart showing modulation of the relative drop characteristics;

FIG. 6 is a series of charts showing satellite droplet and main drop characteristics varying with duty cycle;

FIG. 7A illustrates another embodiment of the present invention wherein infinite satellite droplets are modulated by offset pulse pairs; and

FIG. 7B describes the offset pulse pairs of FIG. 7A.

### DETAILED DESCRIPTION OF THE INVENTION

The present description will be directed in particular to elements forming part of, or cooperating more directly with, apparatus in accordance with the present invention. It is to be understood that elements not specifically shown or described may take various forms well known to those skilled in the art.

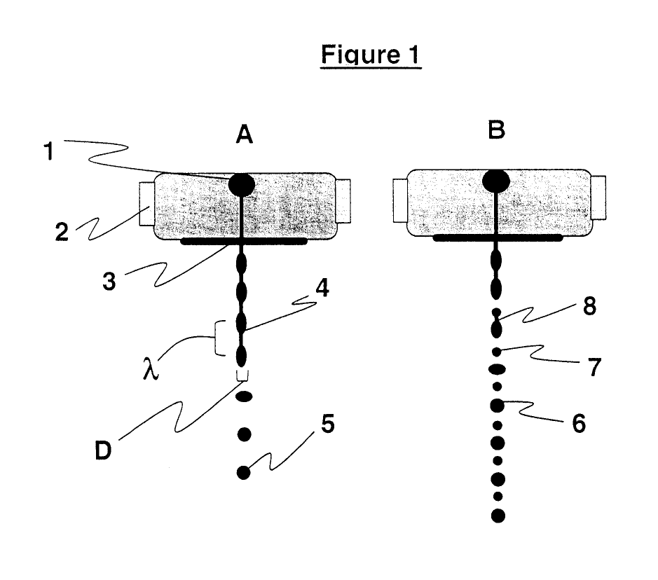

The major components of a continuous ink jet printing system are well known, and have not been illustrated in this disclosure. For those who are unfamiliar with continuous ink jet printing, reference is made, for example, to U.S. Published Application US 2003/0193551 A1. Elements of such a printer that are relevant to the present invention are shown in FIG. 1 of the present disclosure. Generally, an ink supply chamber 1 directs ink toward a nozzle orifice plate 3. A stimulation device 2 is provided to create an ink jet 4 and to control break-off of ink drops 5. While a piezoelectric stimulator has been selected for the illustrated embodiment, it should be understood that one skilled in the art would understand how to apply other stimulation methods according to the present invention.

Ink jet 4 in a print head has a velocity determined, in part, by the pressure of the fluid in chamber 1 behind the nozzles, the diameter/geometry of the nozzles, and the viscosity of the fluid. According to Rayleigh (see generally, Lord Rayleigh, “On the Instability of Jets,” Proc. London Math. Soc. X (1878)) stimulation of the fluid jet by a stimulation device 2 creates perturbations on the fluid jet and if the distance between the perturbations on the fluid jet, defined as λ, is equal to or greater than πD, where D is the diameter of ink jet 4, then the fluid ink jet will produce drops 5 at certain frequencies. If the relation λ/D>π is maintained throughout the stimulation process, the ink jet will eventually break up into a series of drops. The drops produced by this process, referred to as “main drops,” have a volume, V, determined from the flow rate of the ink jet, Qᵥ, and the stimulation frequency, Fₛ, such that V=Qᵥ/Fₛ.

Ink jet printer design requires balancing the desire for increased resolution associated with smaller drop sizes with the disadvantage that the smaller nozzle diameters required to produce small drops are more prone to clogged nozzles and crooked jets. Furthermore, smaller nozzle diameters require higher ink pressures. Accordingly, it is an object of the present invention to provide a method for selectively creating small satellite printing droplets from a large diameter ink jet nozzle. According to a feature of the present invention, the ink jet from a larger nozzle is stimulated in a manner to produce small satellite droplets. The physical size of satellite droplets is significantly smaller than the main drops created from the same size nozzle. Thus, the invention provides a method of selectively creating and controlling satellite droplets, along with the main drop, to allow for printing with a small volume droplet from a large diameter nozzle drop generator.

One method for generating these satellite droplets in a manner that allows selection control and appropriate volumes without changing the physical dimensions of the print head or the operating pressure of the fluid is to stimulate the ink jet in a controlled way to produce an infinite satellite droplet.

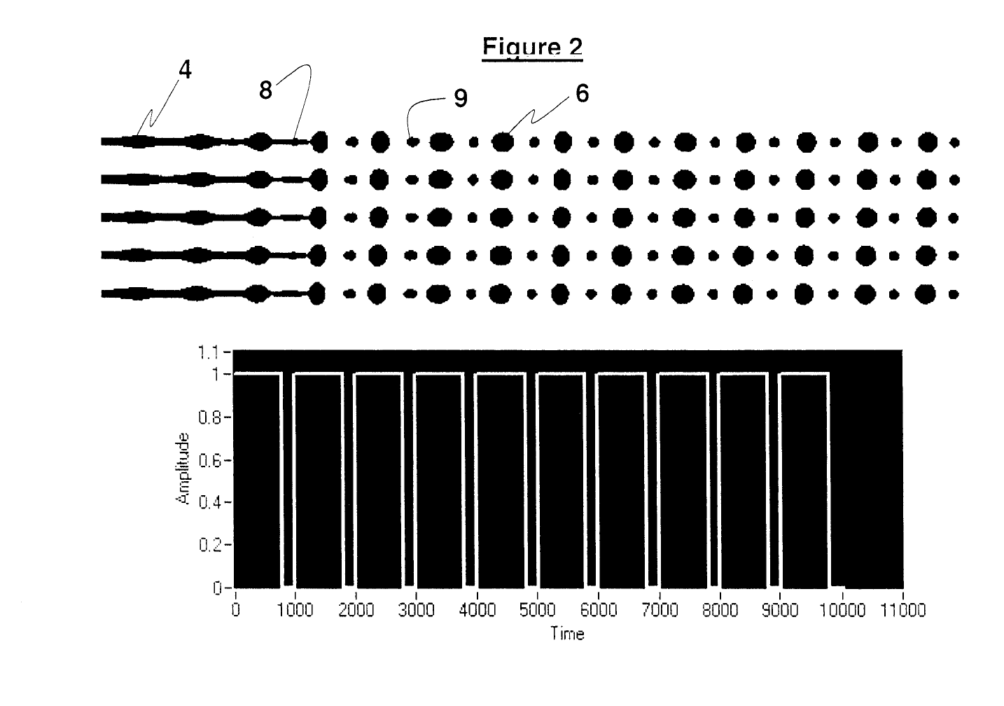

FIG. 1B illustrates the creation of a satellite droplet 7 from a stranded fluid ligament 8 between the main drops and the ink jet at the drop break off point. The production of satellite droplets by stimulating continuous jets is well known. Conventionally satellite droplets create printing errors and are considered undesirable. However, the satellite droplets can be useful for ink jet printing when they are produced in a controllable manner according to the present invention. In a stable condition wherein the satellite droplets have a velocity approximating the velocity of the main drops, the satellite droplets will not merge with the main drops for a considerable distance from the nozzle. These droplets, shown in FIG. 2, are referred to as “infinite” satellite droplets 9, which means they have, in the context of a print head, an infinite lifetime.

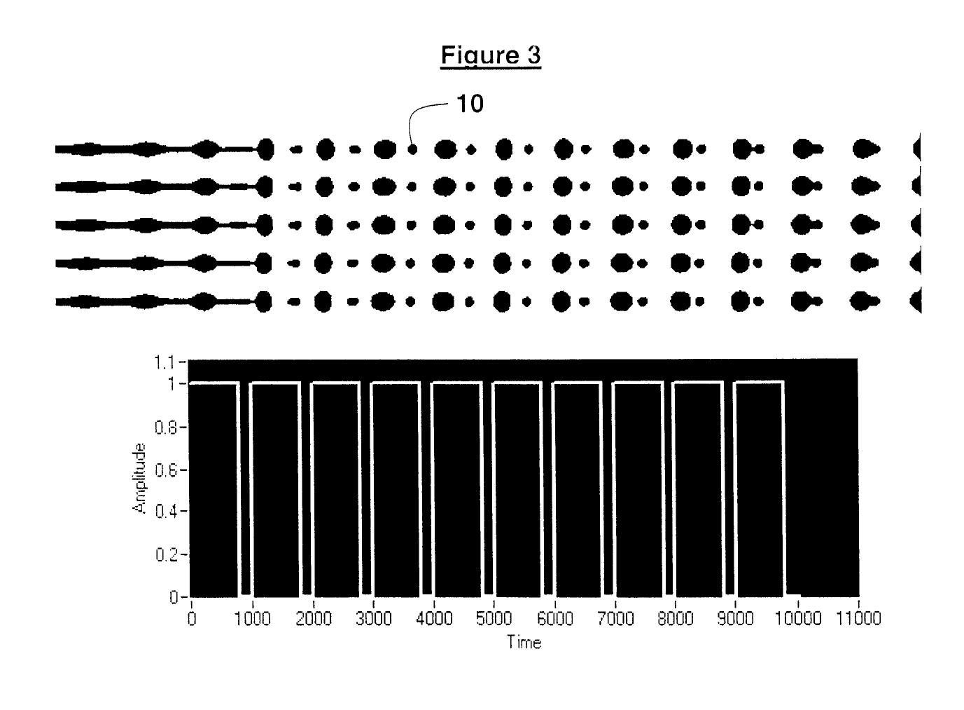

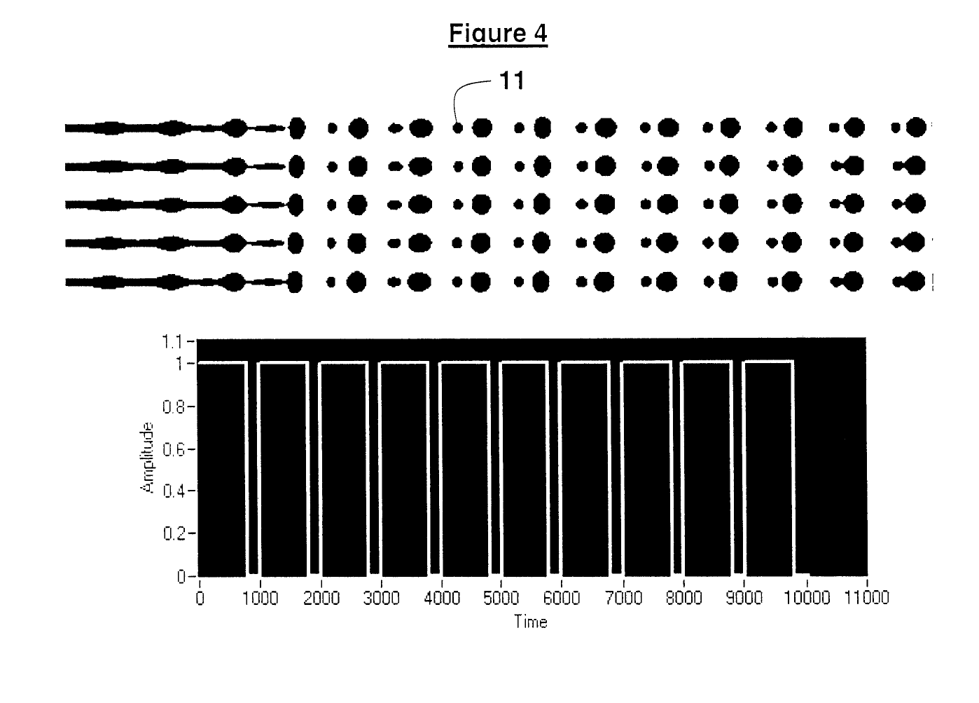

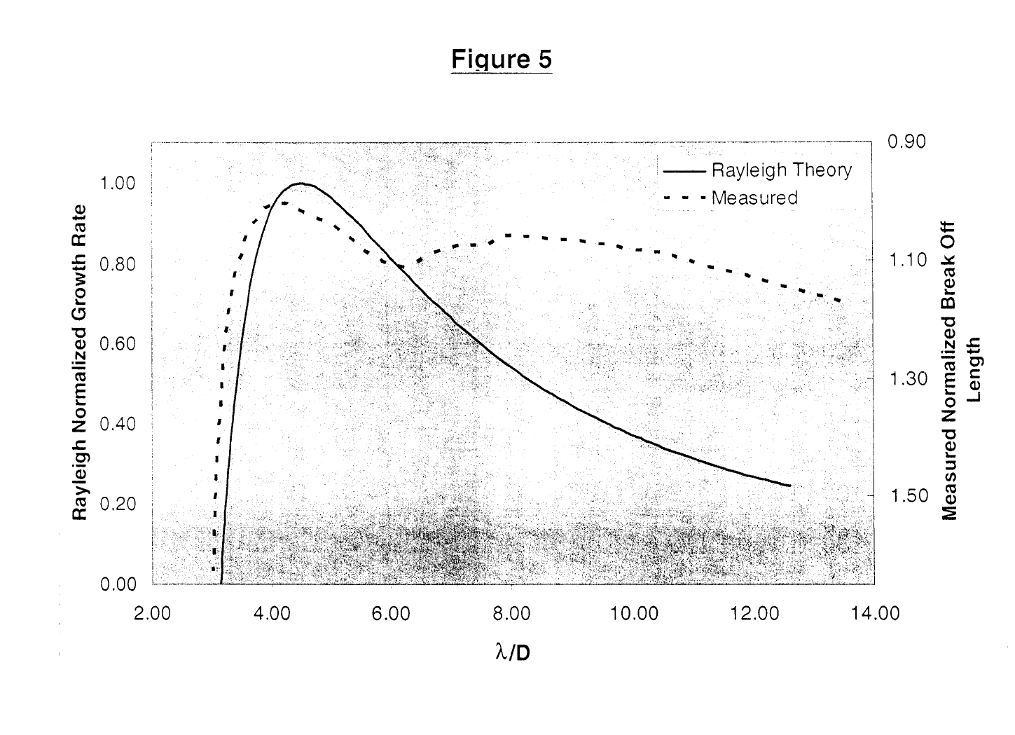

Satellite droplets are typically produced from a continuous ink jet drop generator by adjusting the amplitude and frequency of the ink jet stimulation until a breakup profile similar to that depicted in FIG. 2 is realized. If the satellite droplets have a smaller velocity than the main drops, then these satellite droplets will merge with the main drops immediate to the rear and are referred to as rearward-merging satellite droplets 10 (see FIG. 3). Likewise, if the satellite droplets have a velocity greater than the main drops, the satellite droplets will merge with the main drop immediately preceding and are referred to as forward-merging satellite droplets 11 (see FIG. 4). In both the rearward and forward merging situations, it will be appreciated that the time required for satellite-to-main drop merger is proportional to the differences between their respective velocities.

There is no well-defined velocity difference defining a satellite droplet as infinite, rearward- or forward-merging. In one embodiment, the practical criterion for infinite satellite droplets is a velocity difference that does not produce a satellite-main drop merger before a characteristic distance has been traversed. For example, if the satellite droplets remain unmerged with the main drop through the deflection region of a continuous ink jet print head, then those satellite droplets could be considered infinite. The criterion used for assessing the production of satellite droplets in FIG. 2 was that no merger occurred within 10 λ after droplet break off point.

The preferred, and yet more detailed and complex method of defining the infinite satellite is to consider the values of λ and D. For example, in a drop generator in which a stimulation device surrounds each nozzle for ejecting standard water-based inks, the stimulation device is operable such that it perturbs the surface of the jet of fluid when a driving pulse is received. The driving pulse is defined by shape, amplitude, and duty cycle. When successive drive pulses, having a well-defined frequency, are delivered to the stimulation device, the jet of fluid will break up into a series of equal-volume drops, as mentioned above. Additionally, by operating the stimulation device in a manner to provide a specified λ and D value, it is possible to generate satellite droplets. Particular λ and D value are thus capable of providing the infinite satellite droplet condition, as shown in FIG. 2. For the specific drop generator and stimulation device used in FIG. 2, the λ and D value required for infinite satellite droplet formation occur when λ/D is 6.1. Likewise, other λ and D values would be capable of producing either rearward- or the forward-merging satellite droplets as demonstrated in FIGS. 3 and 4.

The value of λ/D=6.1 for creation of the infinite satellite droplet condition is not arbitrarily. As shown in FIG. 5, this value corresponds to an operating point and the location of local minimum in the drop break off length as a function of λ/D. The smooth curve labeled “Rayleigh Theory” is the normalized calculated value of the growth rate associated with a periodic disturbance on the surface of a liquid stream as a function of λ/D obtained from Rayleigh's well-known analysis on liquid jet stimulation. The dashed curve labeled “Measured” in FIG. 5 was created from the normalized measured values of jet break off length as a function of λ/D (shorter break off length corresponds to larger growth rate) with the preferred continuous ink jet system.

As can be seen from FIG. 5, the simple prediction of Rayleigh reasonably describes measured data up to a λ/D or approximately 6. Above this value; however, the measured data departs significantly from the Rayleigh theoretical curve. The transition point at λ/D=6.1 in FIG. 5 indicates the point of agreement-to-disagreement between the theoretical curve and the experimentally measured data. It is the previously stated jet parameter of λ/D˜6 that provides the necessary fluid dynamics to generate the infinite satellite droplets described by the preferred embodiment.

One skilled in the art will notice that the jet disturbance growth minimum will not always be λ/D˜6 for all fluid and drop generator combinations. For example, this minimum has been observed to be as high as 7.5 for some systems, and is generally described as the local minimum in the Rayleigh normalization growth rate for λ/D greater than π. In addition, generation of infinite satellite droplets is not restricted to the value of λ/D that is exactly equal to the minimum, but reflects the preferred embodiment given the printing system and components used for the diagrammed examples. By adjusting the stimulation pulse duty cycle and amplitude, infinite satellite droplets have been generated at λ/D values of up to +/−10% of the growth rate minimum λ/D value.

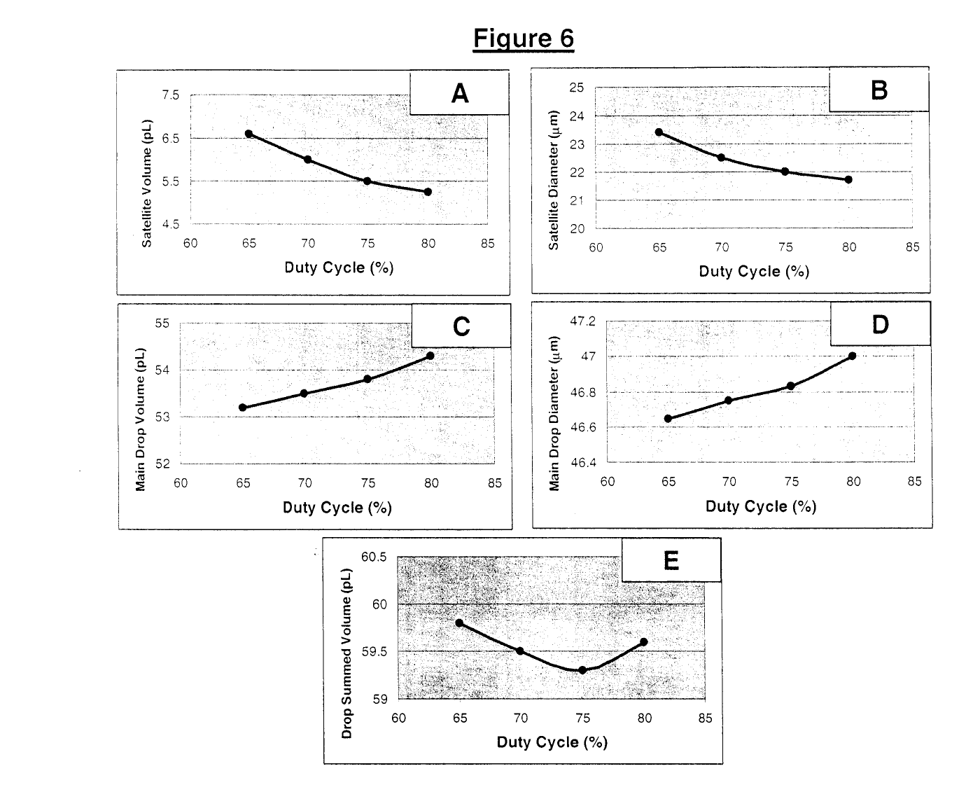

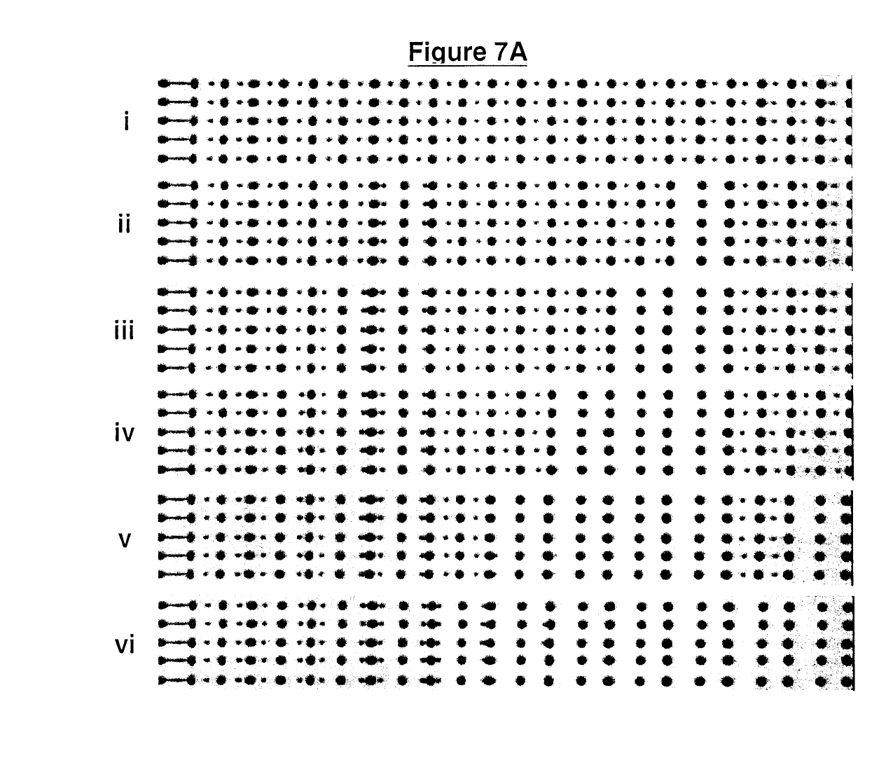

In other embodiments, it becomes possible to control the volume of satellite droplets over a limited range in addition to satellite droplet lifetimes. Referring to FIG. 6, the control over droplet volume modulation is accomplished by adjusting the duty cycle and/or amplitude of the stimulation pulses for a given frequency and jet of fluid velocity. It is the disturbance of the jet of fluid at the growth rate minimum that provides the means for infinite satellite droplet generation and not the actual value of λ/D at that minimum.

The data contained in FIG. 6 demonstrate a relation between satellite droplet volumes (or diameters) and the duty cycle of the continuous ink jet system driven by pulses similar to those shown in FIG. 2. These data reveal the ability of various embodiments to produce satellite droplets of variable volumes by merely changing the duty cycle on the stimulation device. In yet other embodiments, similar results are obtained by varying the pulse amplitude and frequency.

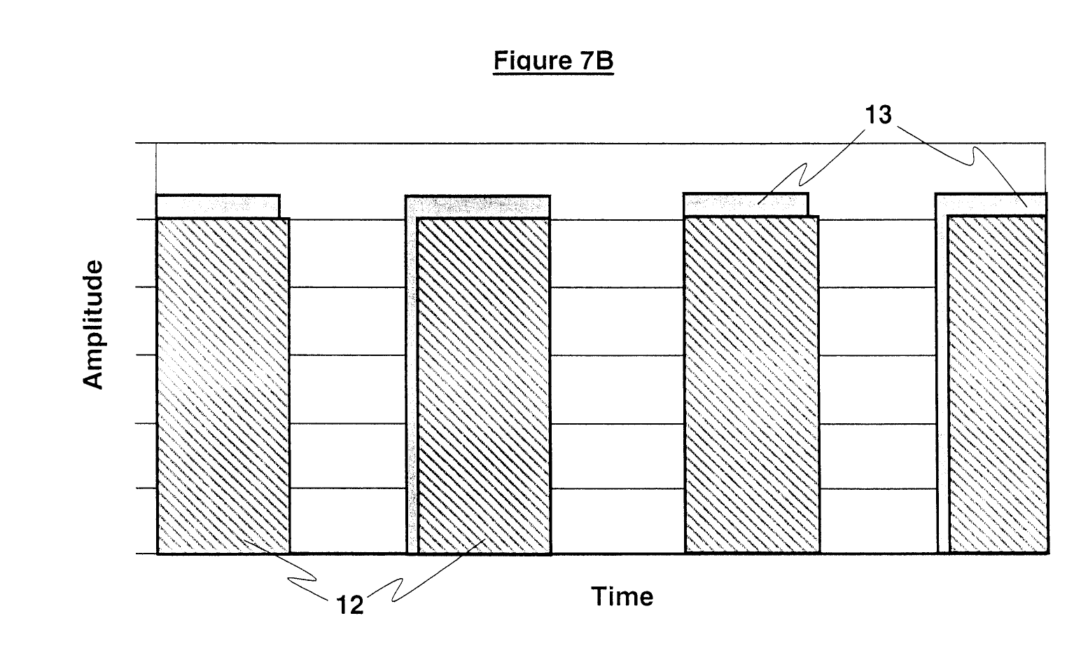

Continuing now to FIGS. 7A and 7B, another embodiment is illustrated wherein the infinite satellite production of a particular ink jet can be modulated in a binary fashion for a single nozzle by replacing an infinite satellite generating pulse pair 12 with an offset pulse pair 13, as described in FIG. 7(B). The offset pulse pairs 13 cause the ink jet break-off dynamics to be modified in such a way that no infinite satellite droplets are produced for two pulse periods. The offset pulse pair 13 replace one infinite satellite generating pulse pair in the pulse train resulting in infinite satellite production control, as shown in FIG. 7(A) images i-vi. Images (i)-(vi) have a constant duty cycle with the periods varying in a pair-wise fashion. The waveform shaded by diagonal-dashes denotes the infinite satellite generating pulse pair 12 while the shaded waveform denotes an example of an offset pulse pair 13. Image (i) demonstrates the continuous cycle of the infinite satellite generating pulse pair 12 waveform. Images (ii)-(vi) show infinite satellite modulation by replacing successive infinite satellite generation cycles with an offset pulse pairs 13. It should be appreciated that the offset pulse pairs 13 have the same amplitude as the infinite satellite generating pulse pair, but have been altered in FIG. 7B to make slight differences apparent and for illustrative purposes only.

The invention has been described in detail with particular reference to certain preferred embodiments thereof, but it will be understood that variations and modifications can be effected within the spirit and scope of the invention.

### PARTS LIST

1) Ink supply chamber
2) Stimulation device
3) Orifice plate
4) Jet of ink
5) Ink drop
6) Main drop
7) Satellite droplet
8) Fluid ligament
9) Infinite satellite droplet
10) Rearward merging satellite droplet
11) Forward merging satellite droplet
12) Infinite satellite generating pulse pair
13) Offset pulse pair

1. A method of forming satellite droplets such that the satellite droplets may have a lifetime selectable between an infinite lifetime and a finite lifetime, said method comprising:
supplying a fluid to a continuous fluid-jet system having a drop generator, a stimulation device, and a nozzle plate with at least one nozzle opening;
applying a force to the fluid such that a fluid jet having a diameter D is ejected from the nozzle openings;
apply an adjustable energy drive pulse to said stimulation device in a manner to create a series of perturbations on the ejected fluid jet, wherein the perturbations are separated by a distance λ;
establishing a first satellite formation state by adjusting the energy of the drive pulse while operating the continuous fluid-jet system in a state wherein values of λ/D are greater than π and correspond to the measured normalized Rayleigh growth rate within or beyond a first minimum; and
adjusting the drive pulse in a manner to bring about a second satellite formation state after at least one λ of the first satellite formation state.

2. A method as in claim 1 wherein the satellite formation state is selectable by altering the pulse duty cycle and keeping the pulse amplitude constant.

3. A method as in claim 1 wherein the satellite formation state is selectable by altering the pulse duty cycle and the pulse amplitude.

4. A method of forming satellite droplets such that the satellite droplets have a lifetime selectable between an infinite lifetime and a finite lifetime, said method comprising:
supplying a fluid to a continuous fluid-jet system comprising a drop generator, a thermal stimulation device, and a nozzle plate with at least one nozzle opening;
applying a force to the fluid such that a fluid jet having a diameter D is ejected from the nozzle openings;
apply an adjustable energy drive pulse to said stimulation device in a manner to create a series of perturbations on the ejected fluid jet, wherein the perturbations are separated by a distance λ; and
adjusting the drive pulse in a manner to bring the continuous fluid-jet system into a state wherein values of λ/D are greater than π and correspond to measured normalized Rayleigh growth rate within or beyond a first minimum.

5. A method as in claim 4 wherein the satellite formation state is created by altering the pulse duty cycle and keeping the pulse amplitude constant.

6. A method as in claim 4 wherein the satellite formation state is created by altering the pulse duty cycle and the pulse amplitude.

7. A method as in claim 4 wherein the thermal stimulation is located at the nozzle openings.

8. A method as in claim 4 wherein the thermal stimulation is created by a light source focusing onto the jet of fluid.
